(19) United States
(12) Patent Application Publication
(10) Pub. No.: US 2025/0176584 A1
(43) Pub. Date: Jun. 5, 2025

(54) Color-Changing Food Product and Method of Making a Color-Changing Food Product

(71) Applicants: Kraft Foods Group Brands LLC, Chicago, IL (US); Sensient Colors LLC, St. Louis, MO (US)

(72) Inventors: Hanna E. Moser, Chicago, IL (US); Jessica Yang, Chicago, IL (US); Lydia Anderson VerLee, Libertyville, IL (US); Zachary Henderson, St. Louis, MO (US)

(21) Appl. No.: 18/526,564

(22) Filed: Dec. 1, 2023

(51) Int. Cl. A23G 3/48; A23G 3/52; A23L 5/43; A23L 5/46; A23L 5/47

(52) U.S. Cl. CPC A23G 3/48; A23G 3/52; A23L 5/43; A23L 5/46; A23L 5/47

(57) ABSTRACT

Food products that change color upon exposure to high heat are provided. In one aspect, the food product includes a primary colorant that exhibits significant loss of color or change in color upon exposure to high heat and at least one additional colorant. The food product may be a marshmallow, marbit, or meringue.

### FIELD

This application relates generally to food products that change color during use.

### BACKGROUND

Visual appearance can be an important initial factor for consumers when selecting food products. Color is one characteristic of food products that can drive consumer interest and purchase decisions. Consumers may find unique colors particularly appealing for novelty food products and dessert items. Certain food products, such as confections, cookies, ice cream and other frozen treats, gums, and candies, and beverages are available in a variety of colors to make the food and beverage items more fun and visually appealing to consumers. Food products might also be provided in certain colors for special events and holiday celebrations, such as red, white, and blue for the Fourth of July or pink and red for Valentine's Day. The color of the product can make a meaningful contribution to the overall enjoyment of preparing, eating, or drinking a product.

### BRIEF DESCRIPTION OF THE DRAWINGS

The patent or application file contains at least one drawing executed in color. Copies of this patent or patent application publication with color drawings will be provided by the office upon request and payment of the necessary fee.

FIG. 1 is a flow diagram of a method of making a color-changing food product.

FIG. 2 is a flow diagram of a method of making a color-changing marshmallow product.

FIG. 3 is a color photograph of two exemplary color-changing food products before and after exposure to high heat.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein are food products that change color upon exposure to high heat. The food products include one or more colorants, in other aspects two or more colorants, to provide the color-changing effect. In some aspects, the food product is a confectionery product, like a marbit, marshmallow, or meringue. The food products may be provided in a variety of colors and then, upon exposure to high heat, the food product changes to a new color. At least in some approaches, the color change is triggered by degradation of one or more of the colorants by exposure to the high heat. It has further been found that combinations of color ingredients can be used to further enhance the color-changing effect. For example, it has been found that certain colorants degrade quickly in high heat while other colorants maintain their color in high heat. Therefore, the identity and amounts of the colorants may be selected to provide a desired color change in terms of color hue and/or intensity.

As used herein, the term “high heat” means a temperature of at least 170° F., such as by exposing the food product to an open flame (e.g., with a cooking torch, gas burner, bonfire, or heating in a conventional oven or with a broiler) for a short period of time. In order to see the color-changing effect, care should be taken that the food product is not burned or overly roasted such that the food product takes on a blackened or burnt appearance that would conceal the color-changing effect of the colorant(s).

As used herein, the term “initial color” refers to the color of the food product provided by one or more colorants prior to exposure to high heat. As used herein, the term “second” color” refers to the color of the food product after exposure to high heat. As used herein, the term “color-changing” or similar term means that the food product undergoes a distinctive visual change from an initial color to a second color. For example, one or more colorants may be included to provide one of a pink, orange, blue, green, yellow, red, purple, or green color to the product. Upon exposure to high heat, the product changes to a different one of pink, orange, blue, green, yellow, red, purple, or green color. The overall color change of the food product is not merely from one color to a lighter or darker shade of the same color, though individual colorants might undergo a color change to a lighter or darker shade of the same color.

The color change effect may be due to one or more of the colorants in the food product exhibiting a significant loss of color, increase in color, or other color change upon exposure to high heat. As used herein, a significant or substantial loss of color or increase of color means that a food product containing that colorant as the only colorant will exhibit a color change upon exposure to high heat that is detectable to the human eye. For example, a visible color change may mean a change of at least 10%, at least 20%, at least 30%, at least 40%, or at least 50%, as measured by a colorimeter.

The food product should also be one that makes it possible to visualize the initial color of the food product as well as the second color after exposure to high heat. For that reason, to be able to appreciate the color-changing effect, food products are preferred that are white or other light or cream color prior to addition of any colorants. In contrast, food products that include dark ingredients, such as cocoa or peanut butter, may prevent the initial color and/or the second color of the food product from being visualized.

In one approach, the food product disclosed herein is a food product that is commonly exposed to high heat during a cooking process or other user experience. In one aspect, the food product may be a confectionery product, such as a whipped or aerated food product. For instance, aerated food products that are commonly exposed to high heat include marshmallows, marbits, and meringue. Marshmallows or marbits may be exposed to high heat during a user experience (e.g., a roasting process when making smores). As another example, marshmallows might be melted in a vessel on the stove during preparation of a marshmallow crispy treat. A meringue may be exposed to high heat during a cooking process, such as a meringue of a pie that is baked in an oven or a meringue included in a Baked Alaska-type dessert that is treated in a flambé step.

In another aspect, the food product may include a non-aerated product that is exposed to high heat during the cooking process or user experience. For example, non-aerated food products include frosting, icing, or other coating for a toaster pastry that may be exposed to high heat during toasting or other heating step.

### Colorants

As used herein, a “colorant” is a food grade substance, including food grade dyes or other pigments, that is added to a food product to change the color of the product. The colorants may be selected from natural colorants, artificial colorants, or combinations thereof. The source or type of colorant is not believed to be particularly limited so long as the colorant or combination of colorants provides a visual color effect to the food product in an amount that doesn't contribute an undesirable amount of off-flavors, textural defects, or other undesirable characteristics or organoleptic properties to the resulting food product. When selecting the colorants, care should be taken that the colorants do not create off flavors in the food product when included in the amounts necessary to create the desired color change.

The food products provided herein include at least one colorant that demonstrates loss of color, increase in color, or other color change upon exposure to high heat. One or more additional colorants may be included that may or may not exhibit loss of color, increase color, or other color change upon exposure to the high heat. Indeed, not all of the colorants included in the food product must demonstrate loss of color, increase of color, or other color change upon exposure to high heat to provide a color changing effect to the food product. Instead, inclusion of one or more colorants that substantially maintain their color upon exposure to high heat in combination with one or more colorants that lose their color or change color upon exposure to high heat can provide a unique color changing effect. For example, degradation or change in color by one colorant upon exposure to high heat can then reveal the color contributed by a non-degrading colorant. The non-degrading colorant might also strengthen the hue and/or intensity of the resulting color after exposure to high heat.

Suitable food-approved artificial colorants that may include, for example, colorants certified by the U.S. Food and Drug Administration as being safe for food and drug use (FD&C colors). FD&C colors include Yellow #5 (tartrazine), Yellow #6 (sunset yellow), Red #3 (erythrosine), Red #40 (Allura Red AC), Blue #1 (Brilliant Blue FCF), Blue #2 (Indigotine), Green #3 (Fast Green FCF), and any combination thereof.

Suitable food-approved natural colorants include, for example, vegetable-based colorants (e.g., beetroot, carrot), fruit-based colorants (e.g., grape, apple), flowering plant-based colorants (e.g., hibiscus), tea-based colorants, cyanobacteria (e.g., spirulina), and any combination thereof.

### Primary Colorant

The at least one colorant that exhibits loss of color, increase in color, or change in color (visible to the human eye) upon exposure to high heat may be referred to as a “primary” colorant. Loss of color or change in color may be due to degradation of the colorant and/or other chemical or physical change to the colorant. For example, certain colorants may exhibit a dramatic change in hue or loss of color upon exposure to high heat. For example, most natural colorants exhibit a loss of color upon exposure to high heat. While most artificial colorants are generally heat stable, Red #3 changes from a bright red to brown when exposed to high heat. The precise mechanism of the color loss is not believed to be limiting. Other primary colorants may have a unique reaction to exposure to high heat, including an increase in color intensity or brightness. For example, turmeric changes from a light orange color to a bright orange color upon exposure to high heat which is believed to be due to a shift of the chemical structure, which also changes the solubility of the colorant. To create the color change effect, the turmeric or other primary colorant may be referred to as “undeveloped,” which means that the colorant has not previously been exposed to high heat when it is added to the food product such that it is capable of exhibiting the loss of color, increase in color, or change in color when exposed to high heat by a consumer.

### Secondary Colorant

Colorants that do not exhibit loss of color or change of color upon exposure to high heat may be referred to as “secondary” colorants. One or more additional colorants may be selected because of desirable heat stability properties. These secondary colorants might also be referred to as “heat-stable” colorants. For example, certain colorants may largely retain their color properties upon exposure to high heat. Synthetic colorants are generally stable upon exposure to high heat with the exception of Red #3. For example, Blue #1, Red #40, and Yellow #6 are highly stable in high heat and demonstrate very minimal loss of color.

As used herein, the terms “primary” and “secondary” do not refer to the respective amounts of the colorants in the product but instead refer to the amount of color change effected by the individual colorant.

The colorants may be included in liquid or powder form. However, at least in some approaches, it has been found to be advantageous to use liquid colorants for ease of production. Powdered colorants may cause clumping or difficulties in obtaining homogenous color distribution during mixing.

In one approach, the food product includes turmeric as a primary colorant and is included in an amount effective to create a visible color difference to the food product upon addition of the turmeric. The amount of the primary colorant included in the food product should also be a sufficient amount to visualize the change in color of the turmeric upon exposure to high heat. The amount of turmeric necessary to alter the color of the food product may depend on the type of food product being prepared and the starting color of the food product prior to addition of any colorants.

The amount of each colorant included in a given food product will depend, at least in part, on the concentration of the colorant (e.g., pigment content of the colorant), the intensity of the color, characteristics of the food product the colorant is added to, and the desired color changing effect in the final product. For example, the color intensity may depend on the wavelength of the light absorbed by the colorant, where a higher intensity will result in a more bright and vibrant color.

For example, turmeric may be included in a food product as a primary colorant in amount of about 0.001 wt. % and about 5 wt %, about 0.001 wt. % and about 4 wt %, about 0.001 wt. % and about 3 wt %, about 0.001 wt % to about 2 wt. %, about 0.001 wt. % to about 1 wt. %, about 0.001 wt. % to about 0.5 wt. %, about 0.001 wt. % to about 0.3 wt. %, about 0.01 wt. % to about 0.2 wt. %, about 0.01 wt. % to about 0.15 wt. %, or about 0.03 wt. % to about 0.15 wt. %, based on a total weight of the food product. In one particular approach, the food product is a marshmallow or marbit.

The food product including turmeric as a primary colorant may further include one or more additional primary colorants and/or one or more secondary colorants that enhances the color change of the turmeric upon exposure to high heat.

In one approach, the at least one additional colorant, either as another primary colorant or as a secondary colorant, may be present in an amount of at least about 0.0001 wt. %, at least about 0.0005 wt. %, at least about 0.001 wt. %, at least about 0.005 wt. %, at least about 0.01 wt. %, or at least about 0.05 wt. %. Again, the precise amount of each colorant will depend on the particular colorant used, the other colorant(s) included, the color of the food product the colorants are added to, any off-flavors or textural defects contributed by the colorant, and the desired color changing effect in the final food product. In some aspects, the at least one additional colorant may be included at in an amount of about 0.0001 wt. % to about 5 wt. %, about 0.0005 wt. % to about 5 wt. %, about 0.001 wt. % to about 3 wt. %, about 0.001 wt. % to about 1 wt. %, about 0.001 wt. % to about 0.5 wt. %, about 0.001 wt. % to about 0.1 wt. %, about 0.001 wt. % to about 0.05 wt. %, about 0.001 wt. % to about 0.03 wt. %, about 0.001 wt. % to about to about 0.02 wt. %, or about 0.001 wt. % to about 0.012 wt. %, based on a total weight of the color-changing food product.

For example, the color-changing food product includes turmeric as a primary colorant and at least one of spirulina, Blue #1, Yellow #5, Yellow #6, Red #3, and Red #40 as additional colorant(s).

In one approach, the color-changing food product includes turmeric as a primary colorant and a combination of Red #40 and Blue #1 as additional colorants. This food product has an initial color of blue and changes to green upon exposure to high heat. When exposed to high heat, the turmeric changes from light orange to a bright orange color, and the Red #40 and Blue #1 stay substantially the same colors. Various amounts of each colorant may be included to provide the desired color hue and intensity of change. The change in the turmeric provides an overall color change effect to the food product from blue to green.

In a first example, turmeric is included in an amount of at least about 0.001 wt. %, at least about 0.01 wt. %, or at least about 0.05 wt. %, by weight of the food product. For example, the turmeric is included in an amount of about 0.001 wt. % to about 3 wt %, about 0.001 wt % to about 2 wt. %, about 0.001 wt. % to about 1 wt. %, about 0.001 wt. % to about 0.5 wt. %, about 0.001 wt. % to about 0.3 wt. %, about 0.01 wt. % to about 0.2 wt. %, about 0.01 wt. % to about 0.15 wt. %, or about 0.03 wt. % to about 0.15 wt., by weight of the food product.

In one aspect, the Red #40 may be included in an amount of at least about 0.001 wt. %, at least about 0.01 wt. %, or at least about 0.05 wt. %, by weight of the food product. For example, the Red #40 may be included in an amount about 0.001 wt. % to about 3 wt. %, about 0.001 wt. % to about 1 wt. %, about 0.001 wt. % to about 0.5 wt. %, about 0.001 wt. % to about 0.1 wt. %, about 0.001 wt. % to about 0.09 wt. %, by weight of the food product.

In one aspect, the Blue #1 may be included in an amount of at least about 0.0001 wt. %, at least about 0.0005 wt. %, at least about 0.001 wt. %, or at least about 0.05 wt. %. For example, the Blue #1 may be included in an amount about 0.0001 wt. % to about 1 wt. %, about 0.0005 wt. % to about 1 wt. %, about 0.0005 wt. % to about 0.5 wt. %, about 0.0005 wt. % to about 0.1 wt. %, about 0.0005 wt. % to about 0.05 wt. %, about 0.001 wt. % to about 0.05 wt. %, or about 0.001 wt. % to about 0.01 wt. %, by weight of the food product.

In another approach, the color-changing food product includes turmeric as a primary colorant and a combination of Yellow #6, Red #3, and Red #40. In such an example, the food product has a pink color and changes to an orange color when exposed to high heat. When exposed to high heat, the turmeric changes from a light orange color to a bright orange color, the Red #40 is included in an amount to provide a pink color to the food product and exhibits minimal or no fading upon exposure to high heat, the Red #3 fades upon exposure to high heat and contributes to the color changing effect as it is degraded from the heat, and the Yellow #6 contributes brightness to the final color and creates greater contrast when the color change occurs. The precise amounts of each colorant may be varied to provide the desired hue and color intensity.

In one aspect, turmeric is included in an amount of at least about 0.001 wt. %, at least about 0.01 wt. %, or at least about 0.05 wt. %, by weight of the food product. For example, the turmeric is included in an amount of about 0.001 wt. % to about 3 wt %, about 0.001 wt % to about 2 wt. %, about 0.001 wt. % to about 1 wt. %, about 0.001 wt. % to about 0.5 wt. %, about 0.001 wt. % to about 0.3 wt. %, about 0.01 wt. % to about 0.2 wt. %, about 0.01 wt. % to about 0.15 wt. %, or about 0.03 wt. % to about 0.15 wt., by weight of the food product.

In one aspect, the Red #40 may be included in an amount of at least about 0.001 wt. %, at least about 0.005 wt. %, or at least about 0.01 wt. %, by weight of the food product. For example, the Red #40 may be included in an amount about 0.001 wt. % to about 3 wt. %, about 0.001 wt. % to about 1 wt. %, about 0.001 wt. % to about 0.5 wt. %, about 0.001 wt. % to about 0.1 wt. %, or about 0.001 wt. % to about 0.09 wt. %, by weight of the food product.

In one aspect, the Red #3 may be included in an amount of at least about 0.0001 wt. %, at least about 0.0005 wt. %, at least about 0.001 wt. %, or at least about 0.005 wt. %, by weight of the food product. For example, the Red #3 may be included in an amount about 0.0001 wt. % to about 1 wt. %, about 0.0001 wt. % to about 0.5 wt. %, about 0.0005 wt. % to about 0.5 wt. %, about 0.0001 wt. % to about 0.1 wt. %, about 0.0005 wt. % to about 0.05 wt. %, about 0.001 wt. % to about 0.05 wt. %, or about 0.001 wt. % to about 0.01 wt. %, by weight of the food product.

In one aspect, the Yellow #6 may be included in an amount of at least about 0.00001 wt. %, at least about 0.0001 wt. %, or at least about 0.0005 wt. %, by weight of the food product. For example, the Yellow #6 may be included in an amount about 0.00001 wt. % to about 1 wt. %, about 0.00005 wt. % to about 0.5 wt. %, about 0.0001 wt. % to about 0.5 wt. %, about 0.0001 wt. % to about 0.1 wt. %, about 0.0005 wt. % to about 0.05 wt. %, about 0.0005 wt. % to about 0.05 wt. %, or about 0.0005 wt. % to about 0.01 wt. %, by weight of the food product.

For color-changing food products in the form of an aerated confectionery product, such as marshmallows, marbits, or meringue, the food product may further include a stabilizing agent. As used herein, the term stabilizing agent means a food grade ingredient that is effective to create a stable foam or aerated network that forms the structure of the food product. Any suitable stabilizing agent may be used.

Examples of suitable stabilizing agents include gelatin, carrageenan, agar-agar, egg, and any combination thereof. In some approaches, the food product may be plant based. In such an approach, the gelatin may be omitted and, instead, a plant-based ingredient or combination of plant-based ingredients may be included as the setting agent. For example, gelatin may be used as a stabilizing agent for marshmallows, carrageenan may be used for vegan (non-gelatin) marshmallows, and egg may be used for meringue.

In one approach, the stabilizing agent is present in an amount within the range of about 0.1 wt. % to about 10 wt %, about 0.5 wt % to about 7 wt %, or about 1 wt % to about 5 wt %, based on a total weight of the food product.

The confectionery product may further include a saccharide component. The saccharide component may be any monosaccharide, disaccharide, polysaccharide, or combination thereof. Examples of suitable saccharide components include sucrose, fructose, glucose, dextrose, corn syrup, honey, maple syrup, agave, molasses, and any combination thereof.

In one approach, the saccharide component is present in an amount within the range of about 50 wt. % to about 95 wt. %, about 60 wt. % to about 95 wt. %, between about 80 wt. % to about 95 wt. %, and about 85 wt. % to about 95 wt. %, based on a total weight of the food product.

In one approach, water is present in an amount within the range of about 1 wt. % to about 15 wt. %, about 1 wt. % to about 10 wt. %, or about 4 wt. % to about 10 wt. %, based on a total weight of the food product.

In some approaches, the confectionery product may further include a whipping aid. Any suitable whipping aid may be used in the food product. Examples of suitable whipping aids include tetrasodium pyrophosphate (TSPP). It is presently believed that the whipping aid may also improve foam stability.

In one approach, the whipping aid is present in an amount within the range of about 0.001 wt. % to about 5 wt. %, 0.01 wt. % to about 1 wt. %, or about 0.01 wt. % to about 0.5 wt. %, based on a total weight of the food product.

The food product may further include one or more flavors, such as vanilla, fruit flavor, chocolate, spearmint, peppermint, and cinnamon. The flavors may be added in any amount desired to provide a desired flavor profile to the product.

For confectionery-type products, the food product may be provided in any suitable shape for the intended user experience. For example, marshmallows or marbits may be cut or formed into any desirable shape, such as cylinders, spheres, cubes, and the like. The shape of the food product is not believed to be particularly limited so long as it enables the product to be heated in a manner effective to bring about the color-changing effect.

### Method of Making

The color-changing food products may be prepared according to conventional processes. However, the colorants should be incorporated into the conventional processes at a step suitable to keep the colorants from reaching a “high heat” temperature and degrading the colorants to cause the color changing effect to occur prematurely during production. For example, for food processes including a cook step, the colorants should be added after the food product has cooled to a temperature that will not cause color change to occur. For example, for confectionery products like marshmallows, the one or more colorants should be added after any heating steps above 150° F. and generally near the end of the marshmallow-making process.

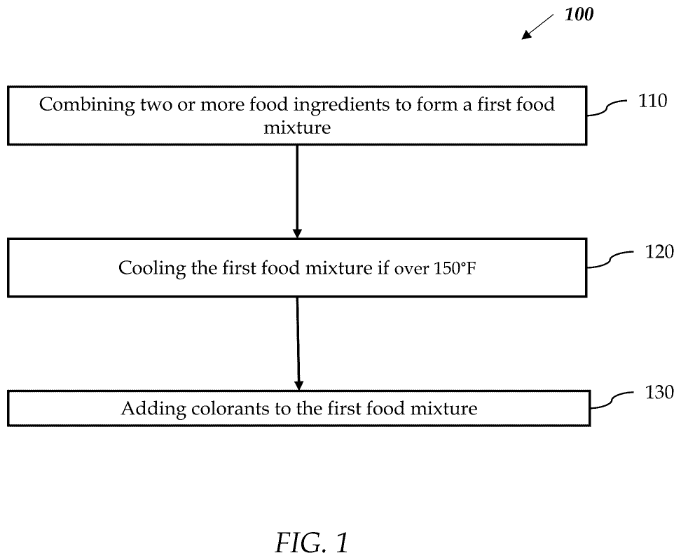

In one exemplary approach, a color-changing marshmallow product can be made by the method illustrated in FIG. 1. The method 100 includes step 110 of combining two or more food ingredients to form a first food mixture. The method may or may not include a heating step for the first food mixture. If the method does include a heating step to a temperature of over 150° F., the first food mixture should be cooled or allowed to cool to a temperature of 150° F. or less. When the first food mixture is at a temperature of no more than 150° F., in step 130, at least one primary colorant that exhibits significant loss of color or color change upon exposure to high heat and at least one additional colorant to form the color-changing food product are added to the first food mixture. If no heating step that raises the food mixture to a temperature of more than 150° F. is included in the method, then no cooling step is required before adding the colorants.

Further steps may be carried out as needed to prepare the final food product. For example, extrusion, mixing, shaping, cutting, or packaging steps may take place using any needed equipment. Those processing steps are not believed to be particularly limited, again so long as the temperature of the food product is kept below 150° F. to avoid prematurely triggering the color change effect. Generally, any flavors are also added after heating steps.

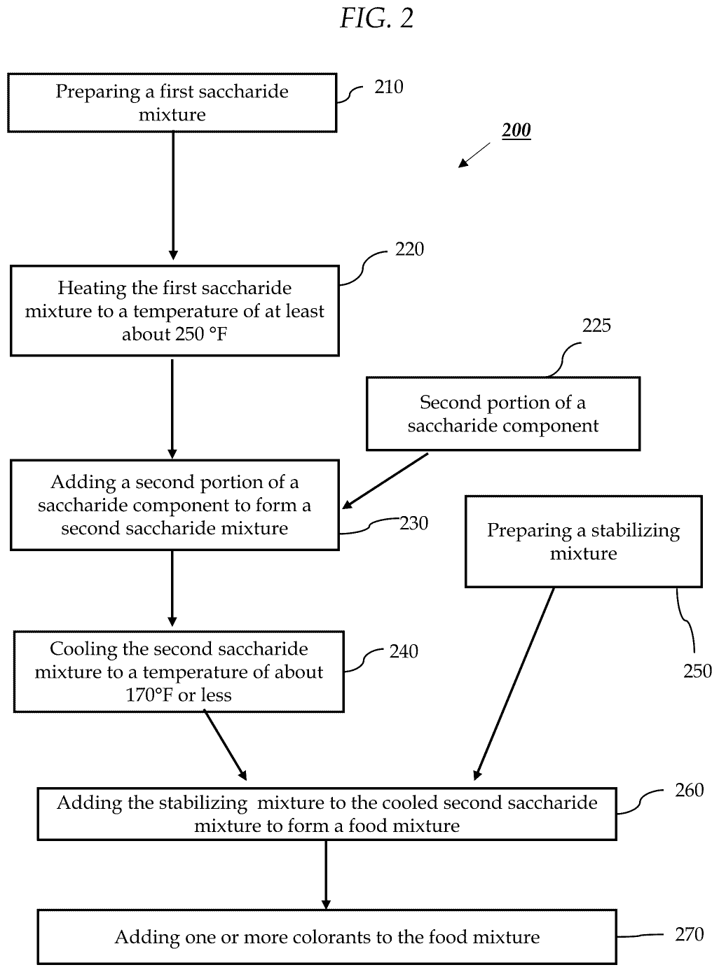

In one exemplary approach, a color-changing marshmallow product can be made by the method 200 illustrated in FIG. 2. In step 210, the method includes preparing a first saccharide mixture including a first portion of a saccharide component and water. The first portion of the saccharide component may include one or more saccharide components. In step 220, the first saccharide mixture is heated to a temperature of at least about 250° F. to bring the first mixture to a boil. In step 230, a second portion of the saccharide component 225 is added to the heated first saccharide mixture to form a second saccharide mixture. In step 240, the second saccharide mixture is cooled to a temperature of about 170° F. or less. In step 250, the method includes preparing a stabilizing mixture including a stabilizing agent, a whipping aid, and water. The stabilizing mixture is then added to the cooled second saccharide mixture in step 260 to form a food mixture. The one or more colorants are added in step 270 to the cooled food mixture. The cooled food mixture may then be aerated or treated in other optional steps to form a marshmallow product. While the steps are described in a particular order, it should be understood that the order of steps may be changed so long as the change of steps does not adversely affect the color-changing effect of the final product.

The method may further include extruding and slicing the marshmallow product into various shapes and sizes, such as cylinders, spheres, cubes, and the like.

The food product may be cooked and processed using any conventional equipment, including the use of a temperature-controlled kettle, such as a steam jacketed kettle, mixing tank, aerator, or other conventional equipment. Cutting and forming the food product into a desired shape may also be accomplished with conventional equipment, such as extruders, knives, depositing manifolds, and molds.

### Method of Using

To cause the color change, a user should expose the color-changing food product to high heat. Exposing the food product to high heat includes any method of heating the food product to a temperature of at least 170° F., such as by exposing the food product to an open flame (e.g., with a cooking torch, gas burner, bonfire, or heating in a conventional oven or with a broiler) for a period of time effective to cause the food product to change from the initial color to the second color. Generally, this might occur for a period of 1 second to about 20 seconds or about 5 to about 15 seconds. However, the precise time for heat treatment may depend on the intensity of the heat source, the type of food product being heated, the mass and/or shape of the food product, the flammability of the food product, and the colorant(s) used in the food product. In order to see the color-changing effect, care should be taken that the food product is not burned or overly roasted such that the food product takes on a blackened or burnt appearance that would conceal the color-changing effect of the colorant(s). The food product should change from one of a pink, orange, blue, green, yellow, red, purple, or green color to the product to a different one of pink, orange, blue, green, yellow, red, purple, or green color.

To further illustrate the present disclosure, examples are given herein. It is to be understood that these examples are provided for illustrative purposes and are not to be construed as limiting the scope of the present disclosure.

### EXAMPLES

### Example 1

Example color-changing marshmallow products were prepared with different colorant combinations. The marshmallow products were prepared according to the following general process. First, water, gelatin, and tetrasodium pyrophosphate in a mixer to form a hydrated gelatin mixture to a temperature to dissolve the gelatin (such as about 130 to 180° F.). Water, dextrose, sugar, and a first portion of corn syrup were separately mixed together in a cooker and cooked to a boil (e.g., a temperature of at least about 252° F.) to form a syrup mixture. The remaining portion of the corn syrup was then added to the syrup mixture. The syrup mixture was removed from the heat and allowed to cool to a temperature of about 160° F. to about 170° F. The gelatin mixture was added to the cooled syrup mixture and stirred to form a liquid marshmallow mixture. When the liquid marshmallow mixture cooled to a temperature of 150° F. or less, the colorants were added to the liquid marshmallow mixture and mixed to form a homogenous mixture with evenly distributed color. Flavorings might also be added at the time of adding the colorants. The final mixture was aerated, extruded, and sliced to form a marshmallow product.

When turmeric was added, it was added separately from other colorants, but a mixture of turmeric and other colorants could be prepared and added together to the marshmallow mixture in a single addition step. The other colorant blends were separately prepared by mixing two or more colorants prior to adding the colorant blend to the marshmallow mixture. The turmeric and spirulina were used in powder form, and the other colorants were included in liquid form.

The formulations of the marshmallow products are shown in Table 1, with the weight percentage of the marshmallow mixture and colorant blend based on the total weight of the final marshmallow product. The colorant blends used to prepare the marshmallow products are also shown in Table 2.

TABLE 1

| | Marshmallow | Marshmallow | Marshmallow | Marshmallow | Marshmallow |
|---|---|---|---|---|---|
| | Sample A | Sample B | Sample C | Sample D | Sample E |
| Ingredient | (wt. %) | (wt. %) | (wt. %) | (wt. %) | (wt. %) |
| Marshmallow | 99.431 | 99.443 | 99.433 | 99.466 | 99.597 |
| Product | | | | | |
| Turmeric | 0.092 | 0.060 | 0.069 | 0.070 | 0.058 |
| Spirulina | — | — | — | 0.414 | 0.345 |
| Colorant | 0.498 | 0.498 | 0.498 | 0.050 | — |
| Blend | | | | | |
| TOTAL | 100.00 | 100.00 | 100.00 | 100.00 | 100.0 |
| Colorant Blend | | | | | |
| (by wt % of the | | | | | |
| total product): | | | | | |
| Yellow #6 | 0.0009 | — | — | — | — |
| Red #3 | 0.0090 | — | — | — | — |
| Red #40 | 0.0178 | 0.0764 | 0.0028 | — | — |
| Blue #1 | — | 0.0015 | 0.0373 | 0.0500 | — |

TABLE 2

| | Colorant | Colorant | Colorant | Colorant |
|---|---|---|---|---|
| | Blend A | Blend B | Blend C | Blend D |
| Ingredient | (wt %) | (wt %) | (wt %) | (wt %) |
| Yellow #6 | 0.19 | — | — | — |
| Red #3 | 1.80 | — | — | — |
| Red #40 | 3.58 | 15.35 | 0.57 | — |
| Blue #1 | — | 0.30 | 7.50 | 100.00 |
| Water | 94.43 | 84.35 | 91.93 | — |
| TOTAL | 100.00 | 100.00 | 100.00 | 100.00 |
| Relative Amounts | | | | |
| of Colorants: | | | | |
| Turmeric:Yellow | 1:0.01:0.1:0.2 | — | — | — |
| #6:Red #3:Red | | | | |
| #40 | | | | |
| Turmeric:Red | — | 1:1.3:0.25 | 1:0.04:0.5 | — |
| #40:Blue #1 | | | | |
| Turmeric:Blue | | | | 1:0.7:6 |
| #1:Spirulina | | | | |

While ratios of the colorants are provided in Table 2, the hue and intensity of color provided by a given colorant will ultimately depend on the concentration of a given colorant.

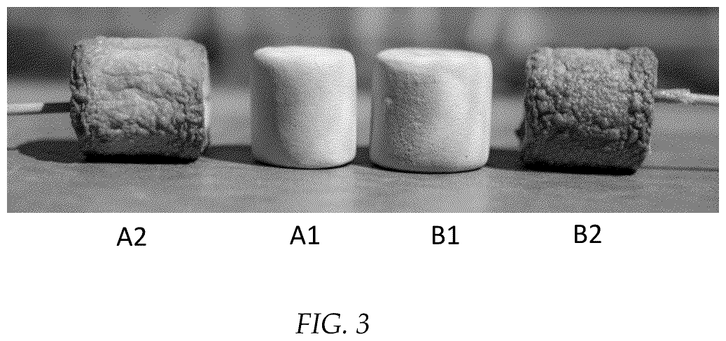

For Sample A, the final marshmallow product was pink in color. As shown in FIG. 3, when exposed to high heat, the final marshmallow product changed from a pink color A1 to an orange color A2.

For Sample B, the final marshmallow product was blue in color. As shown in FIG. 3, when exposed to high heat, the final marshmallow product changed from a blue color B1 to a green color B2.

For Sample C, the final marshmallow product was blue in color. When exposed to high heat, the final marshmallow product changed from a blue color to a green color.

For Sample D, the final marshmallow product was blue in color. When exposed to high heat, the final marshmallow product changed from a blue color to a bluish green color.

For Sample E, the final marshmallow product was blue in color. When exposed to high heat, the final marshmallow product changed from a blue color to a bluish green color.

It is to be understood that the ranges provided herein include the stated range and any value or sub-range within the stated range. For example, a range of about 5 wt % to about 15 wt % should be interpreted to include not only the explicitly recited limits of range of about 5 wt % to about 15 wt %, but also to include individual values, such as 6.35 wt %, 7.5 wt %, 10 wt %, 12.75 wt %, 14 wt %, etc., and sub-ranges, such as about 7 wt % to about 10.5 wt %, about 8.5 wt % to about 12.7 wt %, about 9.75 wt % to about 14 wt %, etc. Furthermore, when “about” is utilized to describe a value, this is meant to encompass minor variations (up to +/−10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A color-changing food product, the food product comprising:
a mixture of two or more food ingredients;
at least one primary colorant that exhibits significant loss of color, increase in color, or change in color upon exposure to high heat; and
at least one additional colorant,
wherein the at least one primary colorant and at least one additional colorant are included in amounts effective to provide a color to the food product that changes from one of a pink, orange, blue, green, yellow, red, purple, or green color to another of a pink, orange, blue, green, yellow, red, purple, or green color upon exposure to high heat.

2. The color-changing food product of claim 1, wherein the at least one primary colorant includes at least two of turmeric, spirulina, and Red #3.

3. The color-changing food product of claim 2, wherein the at least one primary colorant includes turmeric and Red #3.

4. The color-changing food product of claim 1, wherein the at least one additional colorant includes at least one secondary colorant selected from Blue #1, Yellow #6, and Red #40.

5. The color color-changing food product of claim 2, wherein the at least one primary colorant includes turmeric and Red #3, and the at least one additional colorant includes Yellow #6 and Red #40.

6. The color color-changing food product of claim 2, wherein the at least one primary colorant includes turmeric, and the at least one additional colorant includes Red #40 and Blue #1.

7. The color-changing food product of claim 1, wherein the food product is a marshmallow, marbit, or meringue.

8. The color-changing food product of claim 7, wherein the food product is a marshmallow.

9. A method of making a color-changing food product, the method comprising:
combining two or more ingredients to form a food mixture; and
when the food mixture is at a temperature of no more than 150° F., adding at least one primary colorant and at least one additional colorant to form the color-changing food product,
wherein the at least one primary colorant and at least one additional colorant are included in amounts effective to provide a color to the food product that changes from one of a pink, orange, blue, green, yellow, red, purple, or green color to another of a pink, orange, blue, green, yellow, red, purple, or green color upon exposure to high heat.

10. The method of claim 9, wherein combining two or more ingredients to form the food mixture comprises combining a stabilizing agent, a whipping aid, a saccharide component, and water; and the method further comprising aerating the color-changing food product to provide the color-changing food product, wherein the color-changing food product is a color-changing marshmallow product.

11. The method of claim 10, wherein combining two or more ingredients to form a first food mixture comprises combining a stabilizing agent, a whipping aid, a saccharide component, and water includes:
preparing a first saccharide mixture including a first portion of a saccharide component and water;
preparing a stabilizing mixture including a stabilizing agent, a whipping aid, and water;
heating the first saccharide mixture to a temperature of at least about 250° F.;
adding a second portion of the saccharide component to the heated first saccharide mixture to form a second saccharide mixture;
cooling the heated second saccharide mixture to a temperature of about 170° F. or less; and
adding the stabilizing mixture to the cooled second saccharide mixture to form the food mixture.

12. The method of claim 9, wherein the at least one primary colorant includes turmeric.

13. The method of claim 9, wherein the at least one primary colorant includes at least two of turmeric, spirulina, and Red #3.

14. The method of claim 9, wherein the at least one primary colorant includes turmeric and Red #3.

15. The method of claim 9, wherein the at least one additional colorant includes at least one secondary colorant selected from Blue #1, Yellow #6, and Red #40.

16. The method of claim 9, wherein the at least one primary colorant includes turmeric and Red #3, and the at least one additional colorant includes Yellow #6 and Red #40.

17. The method of claim 9, wherein the at least one primary colorant includes turmeric, and the at least one additional colorant includes Red #40 and Blue #1.

18. A method of changing a color of a color-changing food product, the method comprising:
heating the color-changing food product according to claim 1 to a temperature of at least about 170° F.

19. The method of claim 18, wherein the at least one primary colorant includes at least two of turmeric, spirulina, and Red #3.

20. The method of claim 18, wherein the at least one additional colorant includes at least one secondary colorant selected from Blue #1, Yellow #6, and Red #40.
